(19) United States
(12) Patent Application Publication
(10) Pub. No.: US 2018/0049850 A1
(43) Pub. Date: Feb. 22, 2018

(54) DENTAL AUXILIARY STRUCTURE AND MANUFACTURING METHOD

(71) Applicant: FORSTGARTEN INTERNATIONAL HOLDING GMBH, St. Gallen (CH)

(72) Inventors: Guido GASSLER, Ulm (DE); Stefan KALTENBACH, Rebstein (CH)

(21) Appl. No.: 15/555,899

(22) PCT Filed: Mar. 3, 2016
(86) PCT No.: PCT/EP2016/054537

§ 371 Date: Sep. 5, 2017

(30) Foreign Application Priority Data
Mar. 6, 2015 (EP) 15157965.3

(51) Int. Cl. A61C 13/00; A61C 1/08; A61C 5/50

(52) U.S. Cl. CPC A61C 13/0003; A61C 5/50; A61C 1/082

(57) ABSTRACT

It is described an auxiliary structure (240, 440, 540) for treatment of at least one tooth (123) of an upper jaw (100) and/or lower jaw (120), the auxiliary structure comprising: a body (241), in particular comprising a plastic material; the body having a lower surface (233) and an upper surface (235), which are defined based on a lower border (665, 765) of a lower volume (666) occupied by lower teeth of the lower jaw in a bite state and an upper border of an upper volume occupied by upper teeth of the upper jaw in the bite state, wherein the lower surface (233) and/or the upper surface (235) comprises at least one recess (257) with respect to the lower border and/or the upper border, respectively, and/or a common annular edge (247, 251, 253, 255) limiting a through hole (249, 252, 254, 256) through the body (241).

The present invention relates to an auxiliary structure for treatment of at least one tooth and to a manufacturing method for manufacturing the auxiliary structure.

### PRIOR ART

A tooth of an upper jaw or a lower jaw may require treatment for restoring structure, morphology and function. Conventionally it is known to provide a filling or to adhere a pre-fabricated supplement, such as a crown, a bridge, an inlay onto or close to the affected tooth or several affected teeth. Furthermore, when a portion of a tooth or portions of several teeth interfere with a bite motion or a chewing motion, these portions have been removed in a conventional treatment procedure. Thereby, for example the dentist asks the patient to bite onto a piece of paper that changes color in dependence of a localization of tooth contact points during the biting.

It has, however, been observed that the application of a dental supplement to one or more teeth in a viscous, liquid or pre-fabricated form as well as the appropriate removal of portions of one or more teeth is cumbersome and often also too inaccurate.

Thus, there may be a need for a dental auxiliary structure facilitating a dental treatment by the dentist, wherein the treatment may comprise applying a dental supplement onto one or more teeth and/or enabling an accurate removal of portions of one or more teeth that interfere with the function of biting or chewing using the set of teeth in the upper jaw and the lower jaw.

### SUMMARY OF THE INVENTION

This need is satisfied by the subject-matter of the independent claims. The dependent claims specify particular embodiments of the present invention.

According to an embodiment of the present invention a (dental) auxiliary structure (aiding a dentist and to be used by a dentist during a treatment session) for treatment (e.g. applying a dental supplement and/or removing a portion of one or more teeth) of at least one tooth (in particular exactly one tooth or two or more teeth) of an upper and/or lower jaw is provided, in particular a product individually adapted to the mouth or denture anatomy of the patient to be treated.

Thereby, the auxiliary structure comprises a body which may in particular comprise a plastic material (potentially composite plastic material, also comprising fiber material for enforcing the strength). The body thereby has a lower surface (to face or contact the lower teeth of the lower jaw during the treatment) and an upper surface (to face or contact the upper teeth of the upper jaw during the treatment). The lower surface alone, the upper surface alone or both the lower surface and the upper surface may contact the respective teeth of the respective jaw during the treatment. Thereby, the lower surface and the upper surface are defined based on (e.g. depending on, not necessarily coinciding with) a lower border of a lower volume occupied by lower teeth of the lower jaw in a bite state (or in several bite states as adopted during a chewing motion) and based on an upper border of an upper volume occupied by upper teeth of the upper jaw in the bite state (or the several bite states). Alternatively, the lower surface and the upper surface may be defined based on the lower border alone or the upper border alone, for example in cases where only a tooth of the lower jaw or a tooth of the upper jaw requires treatment. The lower surface and/or the upper surface are not required to exactly match the lower border and the upper border. Instead, the lower surface and/or the upper surface comprise at least one recess (such as a concave cavity, a void space) with respect to the lower border and/or the upper border and/or an annular edge (common to the lower surface and/or the upper surface) limiting a through-hole through the body.

The auxiliary structure may be manufactured for example based on a conventional dental imprint and/or based on a 3D model of the upper teeth/jaw and lower teeth/jaw and the auxiliary structure may be used by a dentist during a treatment procedure. The auxiliary structure may facilitate application and/or adhering of a dental supplement (in liquid, viscous or pre-fabricated form) and/or may facilitate removal of a portion of one or more teeth. Thus, the auxiliary structure may be considered as a pattern, edit format, positioning device, or mold facilitating the dental treatment by the dentist.

The auxiliary structure may be utilized on a natural jaw of a patient or on a physical model (e.g. plaster model or plastic model) as derived from a dental cast or imprint, in order to apply a supplement and or to remove a portion of at least on tooth.

According to an embodiment of the present invention the through-hole is in a region of the body where the lower border coincides (or touches or overlaps or penetrates) with the upper border, thereby defining a portion of a tooth of the upper jaw and/or a tooth of the lower jaw to be diminished (where portions of the tooth are to be removed, for example by grinding, cutting or a combination thereof) for improving a bite state or a chewing motion. Thus, the edge may surround a portion of the tooth to be removed.

Further, in particular, the edge of the through-hole may visually and/or hapticly be marked, in particular using color and/or texture and/or a recognizable surface property that differs when compared to non-marked regions of the body. Thereby, an aid is provided for the dentist to indicate where portions of a tooth are to be removed. For example, when the dentist inserts the auxiliary structure onto teeth of the lower jaw, a portion of at least one tooth surrounded by the annular edge that is visually and/or hapticly marked may be desired to be removed. Furthermore, when the dentist inserts the auxiliary structure over the teeth of the upper jaw, a portion of a tooth of the upper jaw being surrounded by another annular edge which is also marked may also be required to be removed. Thus, the visually and/or hapticly marking may be provided on the upper surface and/or the lower surface depending on which tooth of which jaw is partly to be removed.

The treatment, for example partial removal of one or more portions of one or more teeth, may be performed while the auxiliary structure is put on or inserted over the respective teeth or while the auxiliary structure has been removed out of the mouth, in order not to destroy the auxiliary structure during a removal procedure, which may include grinding. In the latter case the dentist may visually mark the respective tooth portion which is to be removed such that this particular tooth portion is still recognizable for the dentist, even if the auxiliary structure is removed from the teeth and from the mouth.

According to an embodiment of the present invention the recess defines a volume portion to accompany supplement material (in liquid, viscous or solid form) to be adhered to a tooth that defined a corresponding area of the lower border or the upper border. Thus, the recess was not present in the lower border or the upper border, but represents an artificial portion to be added or supplemented to a particular tooth or particular teeth. The recess may for example comprise a concave cavity, wherein the geometry of the recess may be based on the geometry of the border (lower border or upper border) that is different from the border where the recess is present. Thereby, the geometry, in particular surface geometry of the recess may be adapted to be compatible (e.g. matching, fitting) with the respective opposing tooth or teeth. Thereby, a bite state and/or a chewing motion may be unimpaired when a supplement according to the geometry of the recess has been applied/adhered to a tooth.

According to an embodiment of the present invention the recess is in a lateral region where the upper border and the lower border have a relative distance greater than a threshold and at the same time where the lower border and the upper border are defined by the geometry of opposing teeth. When the distance between the upper border and the lower border is relatively large in a region between opposing teeth, this may indicate that a relatively large gap is present between the opposing teeth in the bite state or during an entire chewing motion. Thus, in this region it may be beneficial for the bite function or chewing function to add or supplement at one or both of the opposing teeth additional supplement material.

Furthermore, the auxiliary structure may comprise a visual and/or a haptic indication at or close to the recess indicating that the recess is intended to be used as temporal supplement housing. Thereby, the dentist may be aided to fill a pre-fabricated supplement or a liquid or viscous filling material into the recess after which the auxiliary structure including the filling material or pre-fabricated supplement may be inserted over the respective teeth and pressed firmly onto the teeth such that the pre-fabricated supplement or the liquid or viscous filling material adheres at the intended tooth or teeth.

According to an embodiment of the present invention the recess is adapted to temporarily accompany a pre-fabricated solid supplement to be adhered to one of the teeth. Thus, the recess may act as a temporal housing of a solid dental supplement. When the solid supplement is housed within the recess, it may be easier for the dentist to accurately place, for example regarding orientation and positioning, the solid supplement at the intended portion of the tooth to be supplemented. Thereby, a dental treatment may be improved and/or accelerated.

Furthermore, even two or more solid supplements or additional liquid filling materials may be applied to several teeth of the upper jaw and the lower jaw during a single usage of the auxiliary structure. For example, solid supplements and/or fillings may be applied both to teeth of the upper jaw and to teeth of the lower jaw by filling the respective recesses with the solid supplement or liquid or viscous filling material and having the patient firmly bite onto the auxiliary structure inserted between the upper teeth and the lower teeth.

According to an embodiment of the present invention a filling material duct in communication with the recess is formed in the body, the filling material duct leading from the upper surface to the lower surface of the auxiliary structure, the upper surface and lower surface comprising the recess, for allowing excess liquid or viscous filling material to be expelled via the filling material duct to the surface of the auxiliary structure different from the surface of the auxiliary structure at which the recess is arranged. Thereby, also potentially trapped air within the recess may be expelled via the filling material duct when the auxiliary structure is pressed against the upper teeth or the lower teeth for applying and adhering the filling material to one or more teeth. The filling material duct may be defined such as to end in a region outside a contact region where upper and lower teeth contact during biting or during a chewing motion. Thus, for example the filling material duct may end at a side surface of the body of the auxiliary structure.

According to an embodiment of the present invention the filling material duct has a lateral extension (for example cross-sectional size, cross-sectional diameter) that is smaller close to the recess than far from the recess, to define a predetermined breaking point (of a solidified filling material) when the auxiliary structure is withdrawn (from the teeth and the mouth) after the filling material has solidified or has been adhered to the tooth.

Thus, the auxiliary structure may easily be removed from the teeth and the mouth. Furthermore, due to the predetermined breaking point the filling material, solidified and adhered to the intended tooth, may firmly stay adhered to the tooth without detaching from the tooth.

According to an embodiment of the present invention the lower border limits a lower volume occupied by the lower teeth during a chewing motion (in particular including several bite states and also states of opening of the upper and lower jaw) and the upper border limits an upper volume occupied by the upper teeth during the chewing motion.

By considering not only one (single) bite state to define the (geometry of the) recess and/or the annular edge, but several bite states and even a chewing motion, may improve the definition of the recess and the annular edge (thereby defining a supplement geometry and a geometry of a teeth portion to be removed), such as to ensure that the portion to be removed and the supplement to be added do not interfere with the normal function of the teeth.

According to an embodiment of the present invention the bite state or the chewing motion is a state or a motion modified from an original bite state or an original chewing motion by repositioning a bite/lower jaw rotation axis. Thereby, a situation is supported in which a repositioning of the bite/lower jaw rotation axis is intended for improving the chewing motion or jaw function. For example, for lowering the lower jaw rotation axis the lower border and the upper border may be removed/spaced apart from each other by a particular intended lower jaw rotation axis lowering amount. Thus, the distance between the lower border and the upper border (as determined in the bite state) may be increased by the amount by which the lower jaw rotation axis is intended to be lowered. In the case the lower jaw rotation axis is to be elevated, the distance between the lower border and the upper border (as determined for the natural bite state) may be decreased. Thereby, an additional treatment procedure by the dentist is supported.

It should be understood that features which have been individually or in any combination disclosed, described, applied or provided for a dental auxiliary structure for treatment of at least one tooth may also be applied to or provided for a method for manufacturing an auxiliary structure according to embodiments of the present invention and vice versa.

According to an embodiment of the present invention it is provided a method for manufacturing an auxiliary structure for dental treatment. Thereby, the method comprises providing a 3D model of an upper jaw including plural upper teeth and a lower jaw including plural lower teeth, using the 3D model to define a lower border of a lower volume occupied by the lower teeth in a bite state and an upper border of an upper volume occupied by the upper teeth in the bite state, defining a geometry of the auxiliary structure based on the lower border and the upper border, thereby providing, in the auxiliary structure, at least one recess with respect to the lower border and/or the upper border, and/or an annular edge common to an upper surface and a lower surface of the auxiliary structure, the common edge limiting a through hole through the auxiliary structure.

The 3D model may for example be obtained or derived from a conventional dental imprint of the upper teeth and the lower teeth during a bite state or during a chewing motion. The auxiliary structure as described in embodiments above may be manufactured by the manufacturing method according to embodiments of the present invention.

The method may further comprise marking the recess and/or the annular edge, indicating to the dentist at which locations what kind of treatment is to be performed. The geometry of the auxiliary structure may for example be defined by the lower surface and the upper surface of the auxiliary structure as mentioned above.

The manufacturing method may further comprise modifying the 3D model by repositioning the lower jaw relative to the upper jaw (or repositioning the lower teeth relative to the upper teeth), in particular repositioning a lower jaw rotation axis (for example lowering or elevating the lower jaw rotation axis). Furthermore, the modified 3D model may be used to define a modified lower border and a modified upper border and the geometry of the auxiliary structure may be defined based on the modified lower border and the modified upper border. Thereby, also an auxiliary structure may be provided when a repositioning of the lower jaw relative to the upper jaw is intended.

The manufacturing method may further comprise manufacturing the auxiliary structure using in particular thermoplastic and/or thermosetting material, in particular a composite material including plastic. All kinds of conventional dental composite materials may be used. The material for manufacturing the auxiliary structure may successively be supplied to the growing auxiliary structure using a 3D printer to which the predefined geometry is supplied. Thereby, a simple and fast manufacturing may be enabled.

Further, the material for manufacturing the auxiliary structure may include fiber material, in particular glass fiber material, such as short fiber sections or an uninterrupted fiber. Thereby, the stability and strength of the auxiliary structure may be improved.

The manufacturing method may further comprise acquiring, at plural time instances during a chewing motion using the teeth, position data representing positions of the upper teeth relative to positions of the lower teeth, using/combining the position data to obtain another lower border of another lower volume occupied by the lower teeth during the chewing motion and another upper border of another upper volume occupied by the upper teeth during the chewing motion, defining another geometry of the auxiliary structure based on the other lower border and the other upper border.

By using the position data representing positions of the upper teeth relative to the position of the lower teeth during the chewing motion to define the other lower border and the other upper border based on which the other geometry of the auxiliary structure is defined, may improve the auxiliary structure in that it may be ensured that the supplement to be added and/or the portion to be removed of the teeth does not interfere with a natural motion or function of the upper jaw and the lower jaw.

Furthermore, the acquiring of the position data may comprise attaching plural position sensors (in particular comprising one or more acceleration sensors and/or gyroscopes) at the lower jaw (or at locations which are fixed relative to the lower jaw) and at a body portion which is fixed relative to the upper jaw. Further, measurement signals are acquired during the chewing motion from the plural position sensors (which in particular transmit the measurement signals wirelessly, in particular using Bluetooth), wherein at least one of the position sensors comprises in particular at least one acceleration sensor (such as a 6-axis or 9-axis acceleration sensor and also including one or more gyroscopes).

To acquire the position data, the upper jaw and the lower jaw may start the chewing motion beginning at a reference position, for example a bite state. The measurements may be repeated several times and the measurement signals may be averaged to improve accuracy. Furthermore, signals from several position sensors may be averaged.

Furthermore, according to an embodiment of the present invention, a method of producing a dental supplement for at least one tooth using an auxiliary structure according to one of the above described embodiments is provided. Thereby the auxiliary structure may be utilized on a natural jaw of a patient or on a physical model (e.g. plaster model or plastic model) as derived from a dental cast or imprint.

Embodiments of the present invention are now described with reference to the accompanying drawings. The invention is not limited to the illustrated or described embodiments.

### BRIEF DESCRIPTION OF THE DRAWINGS

FIGS. 1a, 1b and 1c schematically illustrate perspective views of an upper jaw, a lower jaw, and a model of the assembled upper jaw and the lower jaw;

FIGS. 2a, 2b schematically illustrate an auxiliary structure for treatment of at least one tooth together with an upper and a lower jaw according to an embodiment of the present invention;

FIG. 3 schematically illustrates an auxiliary structure for treatment of at least one tooth according to an embodiment of the present invention;

FIG. 4 schematically illustrates in a cross-sectional side view an auxiliary structure, a tooth and a filling/supplement according to an embodiment of the present invention,

FIG. 5 schematically illustrates in a cross-sectional side view an auxiliary structure for treatment of at least one tooth according to an embodiment of the present invention;

FIG. 6 schematically illustrates in a side view several states during a chewing motion of a tooth employed for defining a geometry of an auxiliary structure according to an embodiment of the present invention; and

FIG. 7 schematically illustrates procedural steps for lowering a lower jaw rotation axis employed for manufacturing an auxiliary structure according to an embodiment of the present invention.

### DETAILED DESCRIPTION OF EMBODIMENTS

It should be noted that elements or features similar in structure and/or function are in different embodiments designated with reference signs differing only in the first digit. Thus, when a particular feature is not described in detail with reference to a particular embodiment, a description of this respective feature may be taken from the explanation of another embodiment.

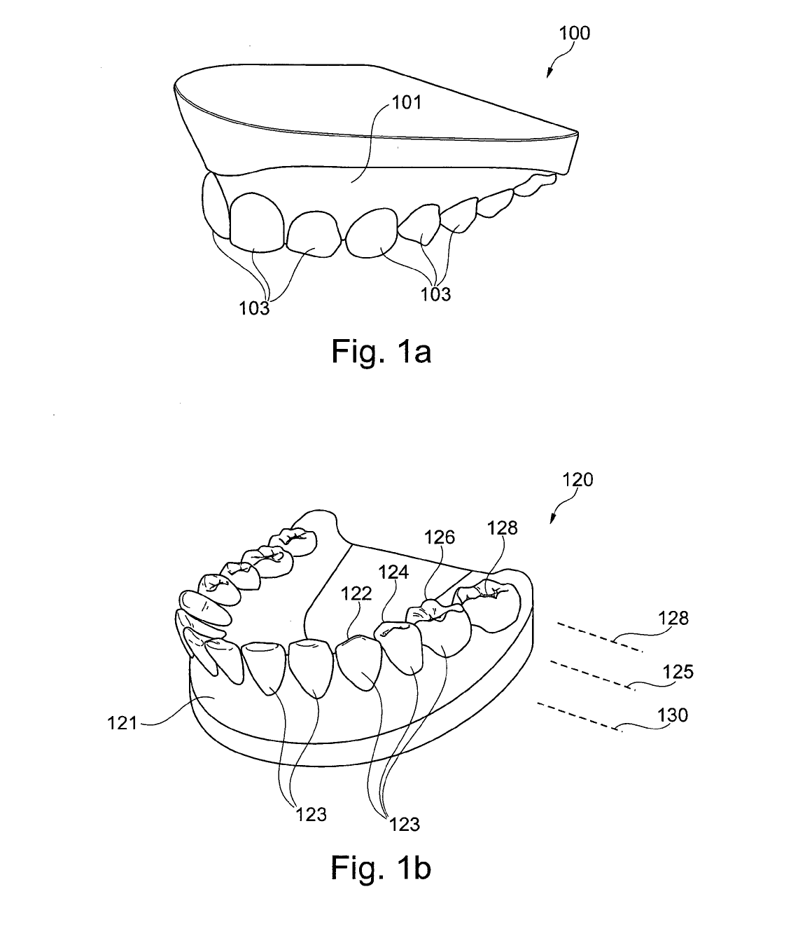

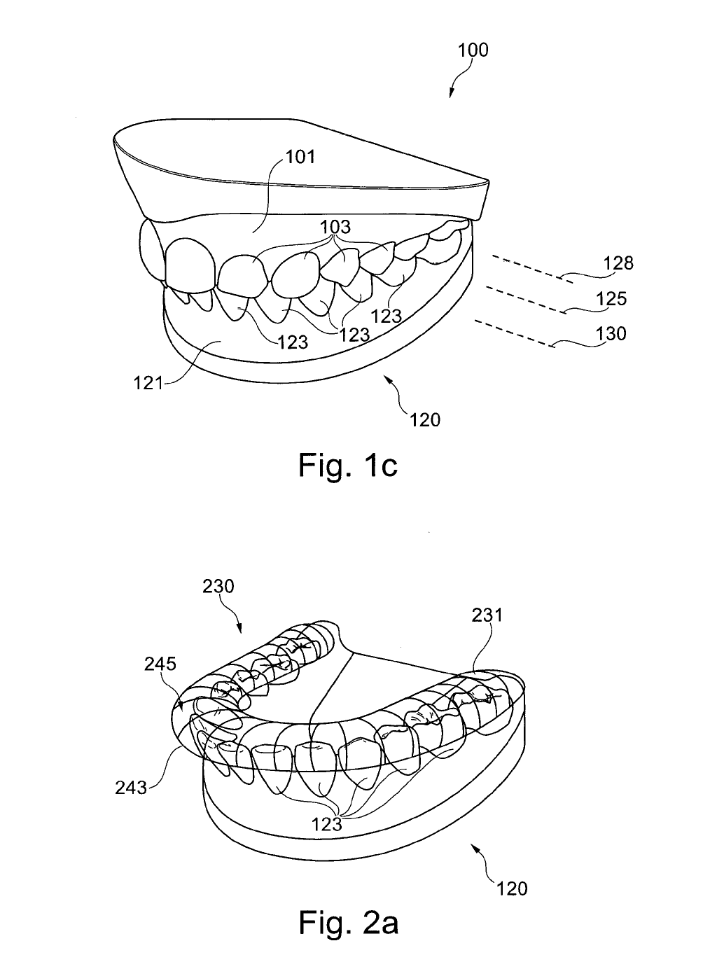

FIGS. 1a and 1b schematically illustrate in perspective views an upper jaw 100 including a teethridge 101 and plural upper teeth 103 and a lower jaw 120 including a teethridge 121 and plural lower teeth 123. One or more of the upper teeth 103 or the lower teeth 123 may require treatment, such as one or more supplements, such as a crown, an inlay, an onlay or one or more removal procedures for removing one or more portions of the teeth 103, 123. Restoration or modification of the teeth 103, 123 may be required due to structure loss of one of the teeth or potentially due to caries or a malposition or defective position in a bite state, such as for example illustrated in FIG. 1c. A defective position or malpositioning may occur during a single bite state or during a chewing motion including several bite states.

During chewing the lower jaw 120 may rotate around a rotation axis 125 which may represent an original rotation axis. A chewing motion may comprise a complicated motion including rotation, translation, in particular translation comprising vertical components and also lateral or side components. In the bite state or during the chewing motion portions of one or more teeth 103, 123 may interfere with, i.e. may impede or obstruct or hinder, the natural chewing motion or may interfere with at least one bite state. Furthermore, extensive void volumes between opposing teeth may be present during the bite state or during an entire chewing motion. The void volumes between opposing teeth may also impair biting or may impair the chewing motion or function.

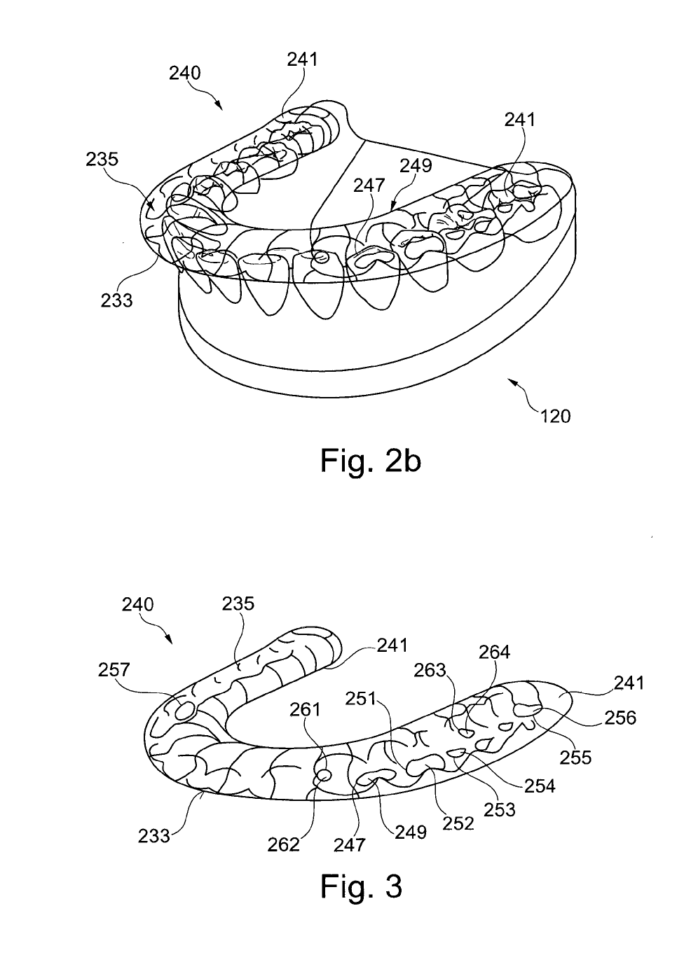

Thus, for improving a bite state and/or an entire chewing motion it may be desired to remove portions of particular teeth and/or add supplements or additional material to other portions of (other) teeth. Embodiments of the present invention provide a dental auxiliary structure, such as illustrated in FIGS. 2a, 2b, 3, 4, 5, which may help or aid the dentist for performing a treatment of the teeth 103, 123 to achieve the afore-mentioned goals.

FIG. 2a schematically illustrates a precursor 230 of an auxiliary structure according to an embodiment of the present invention together with the lower jaw 120 and the lower teeth 123. The precursor 230 of the auxiliary structure comprises a body 231 which comprises plastic material. The body of the precursor 230 has a lower surface 243 and an upper surface 245 which correspond to a lower border of a lower volume occupied by the lower teeth 123 in a bite state and an upper border of an upper volume occupied by the upper teeth 103 in the bite state. Thus, the precursor 230 has a lower surface 243 and an upper surface 245 that substantially corresponds or equals a surface geometry of a dental imprint or dental cast as it has for example been obtained by asking the patient to adopt a bite state when viscous material is placed between the upper jaw 100 and the lower jaw 120.

FIG. 2b schematically illustrates a dental auxiliary structure 240 (placed onto lower teeth) according to an embodiment of the present invention as derived from the precursor auxiliary structure 230 as illustrated in FIG. 2a. FIG. 3 schematically illustrates the dental auxiliary structure 240 according to an embodiment of the present invention taken out of the mouth.

Differing from the precursor auxiliary structure 230 illustrated in FIG. 2a the dental auxiliary structure 240 illustrated in FIG. 2b (together with the lower jaw 120) comprises a lower surface 233 and an upper surface 235 which are only defined based on (but not identical to) the lower border of a lower volume occupied by lower teeth in a bite state and the upper border of an upper volume occupied by upper teeth in the bite state. However, the lower surface 233 and upper surface 235 comprise distinct differences compared to the lower border and the upper border.

For example, the auxiliary structure 240 having the body 241 comprises an annular edge 247 that limits a through-hole 249 through the body 241 of the auxiliary structure 240. In particular, the auxiliary structure 240 comprises a number of edges common to the lower surface 233 and the upper surface 235, namely the annular edges 247, 251, 253, 255 and may comprise even further common edges each surrounding a through-hole 249, 252, 254, 256. Alternatively or additionally the auxiliary structure 240 comprises one or more recesses 257 which have not been present in the upper border or the lower border. The recess 257 is formed by a concave cavity which is adapted to accompany filling material (liquid or viscous) or a pre-fabricated supplement to be adhered or fixed at a corresponding tooth that requires application of a dental supplement.

While the locations of the edges and thus the surrounded through-holes 249, 252, 254, 256 are located at regions where the upper teeth contact or interfere with the lower teeth, the recess 257 is located in a region where, during a bite state or during a chewing motion, a relatively large spaced gap is present between opposing teeth. Thus, the relatively large gap may be desired to be diminished by application of a filling material or adding of a supplement to one or more of the upper teeth or the lower teeth.

The edges 247, 251, 253, 255 surrounding the tooth portion desired to be removed are visually and/or hapticly marked. Other edges 261, 263 which also limit through-holes 262, 264 are not marked with a visual or haptic indication. Thus, the dentist may recognize that tooth portions penetrating through the through-holes 262, 264 and surrounded by the edges 261, 263 are not intended to be removed during a treatment procedure. Those tooth portions may have been determined not to interfere severely with the bite state or a chewing motion.

Furthermore, also the recess 257 may be marked for the dentist to recognize that filling material is to be filled into the recess 257 or a pre-fabricated supplement is to be placed within the recess 257.

The dental auxiliary structure 240 may be placed onto the lower jaw 120 and/or onto the upper jaw 100 during a treatment procedure. Tooth portions to be removed are then recognizable by the dentist as surrounded by the visually or hapticly marked edges 247, 251, 253, 255. The annular edges 247, 251, 253 and 255 may for example surround the portions 122, 124, 126 and 128 (see FIG. 1b) of the lower teeth 123 to be partially removed.

Before inserting or putting over the teeth the auxiliary structure 240 also filling material or a pre-fabricated solid supplement may be placed within the recess 257. The patient may then be asked to close the mouth and firmly apply a bite force to the upper jaw and lower jaw such that the upper teeth 103 and the lower teeth 123 adopt a bite state, having the auxiliary structure 240 placed between the upper teeth 103 and the lower teeth 123.

The recess 257 may define a geometry and location of a supplement to be added to one of the upper teeth 103.

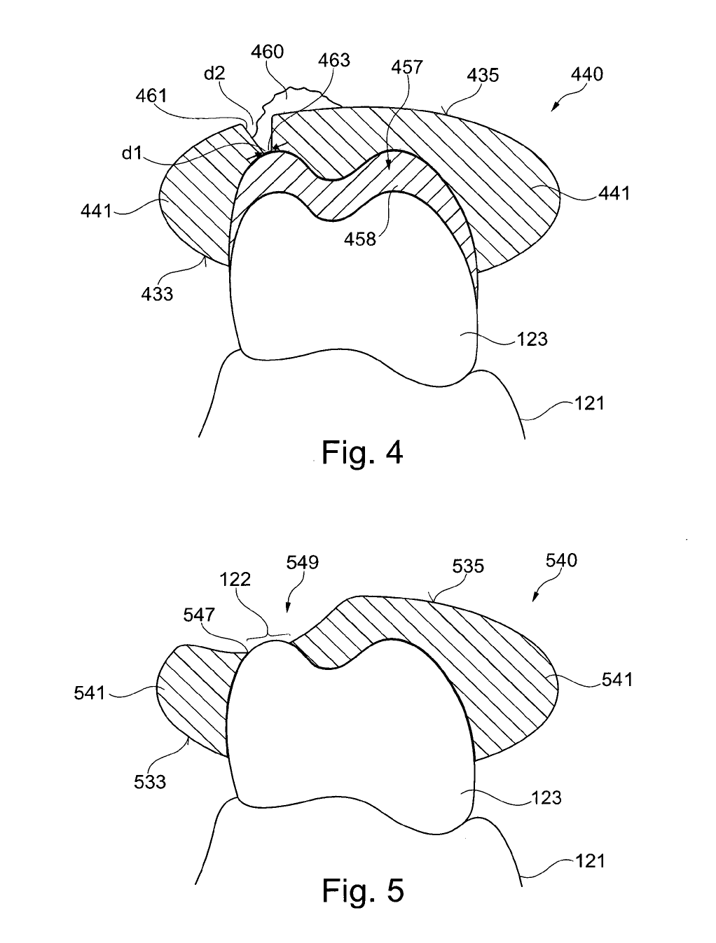

A recess 457 of a dental auxiliary structure 440 is in more detail illustrated in a cross-sectional side view illustrated in FIG. 4. The auxiliary structure 440 according to an embodiment of the present invention comprises a body 441 made of plastic material. The body 441 has a lower surface 433 and an upper surface 435 which may be defined based on a lower border and an upper border of a positive (i.e. 3D model of upper and lower teeth) of a dental imprint obtained in a bite state or during a chewing motion. The auxiliary structure 440, however, comprising (deviating from the lower border of a lower volume occupied by lower teeth in the bite state) a recess 457 which is in FIG. 4 filled with filling material 458. In particular, FIG. 4 illustrates a situation after which the filling material 458 has been filled into the recess 457 and after the auxiliary structure 440 has been firmly pressed onto the tooth 123 of the lower jaw including the teethridge 121.

When the auxiliary structure 440 including the filling material 458 filled into the recess 457 is pressed onto the tooth 123, excess filling material 460 or air may be expelled from the recess 457 via a filling material duct 461. A lateral extension d1 close to the recess is smaller than a lateral dimension or cross-sectional size d2 at the upper surface 435 which is the surface opposing the surface 433 where the recess 457 is arranged. The narrowest point of the filling material duct 461 is labelled with reference sign 463 and represents a predetermined breaking point of the filling material 458, 460. More than one filling material duct 461 may be provided according to different embodiments of the auxiliary structure.

FIG. 5 schematically illustrates a dental auxiliary structure 540 according to an embodiment of the present invention as put over a tooth 123 of a lower jaw including a teethridge 121. The auxiliary structure 540 comprises a body 541 limited by a lower surface 553 and an upper surface 535. The auxiliary structure 540 comprises an annular edge 547 limiting a through-hole 549 through which a portion 122 of the tooth 123 protrudes and is thus exposed. The portion 122 surrounded by the annular edge 547 is intended to be removed during a dental treatment procedure. The edge 547 may carry a visual marking for the dentist to recognize the area or location of the tooth to be partly removed.

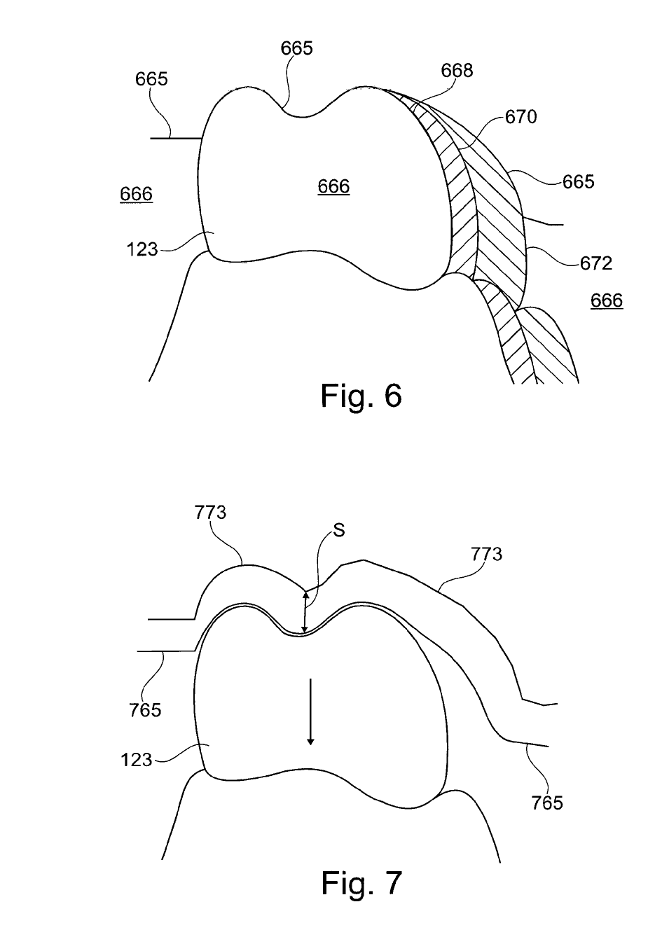

FIG. 6 schematically illustrates a procedure how to define a lower border 665 which may serve to define a lower surface of an auxiliary structure, such as lower surfaces 433, 533 or 233 of the auxiliary structures 240, 440 and 540 illustrated in FIGS. 2b, 3, 4 and 5. For defining the lower border 665 limiting a lower volume 666 occupied by the lower teeth 123 during a chewing motion, position data are acquired during the chewing motion comprising plural bite states or motion states. As an example, in FIG. 6 three motion states of the tooth 123 are depicted, wherein the side border of the tooth 123 adopts the three states 668, 670 and 672. The lower border 665 limits the lower volume 666 which is obtained by including all volume portions which are occupied during the chewing motion by the tooth 123.

In other embodiments the lower border 665 is defined considering a single bite state, such that the lower border may be obtained by creating a positive of a conventional dental imprint.

Based on the lower border 665, a geometry or a dental auxiliary structure, such as the auxiliary structure 240, 440 or 540 may be defined. Thereby, also at least one recess and an annular edge may be provided, as described in detail with reference to FIGS. 2b, 3, 4 and 5.

FIG. 7 schematically illustrates a procedure to modify a lower border in order to arrive at a modified lower border 773 based on which a geometry of a dental auxiliary structure may be defined. In the situation illustrated in FIG. 7 it is intended to reposition the lower jaw rotation axis 125 to the lower axis 130 (see FIG. 1b). Alternatively, it may be desired to elevate the original rotation axis 125 to the elevated rotation axis 128.

The original lower border 765, such as obtained using an imprint or using the procedure as explained with reference to FIG. 6, may be modified or shifted by a particular amount ‘s’ upwards, in order to define the modified lower border 773. One or more recesses, such as recess 257 as illustrated in FIG. 3 or recess 457 as illustrated in FIG. 4 may be provided for the auxiliary structure whose geometry may be defined based on the modified lower border 773.

Thus, according to embodiments of the present invention the dental auxiliary structures 240, 440 and 540 may facilitate a transfer of digital information into the real world for facilitating dental treatment by the dentist.

1. Auxiliary structure (240, 440, 540) for treatment of at least one tooth (123) of an upper jaw (100) and/or lower jaw (120), the auxiliary structure comprising:
a body (241), in particular comprising a plastic material;
the body having a lower surface (233) and an upper surface (235), which are defined based on
a lower border (665, 765) of a lower volume (666) occupied by lower teeth of the lower jaw in a bite state and
an upper border of an upper volume occupied by upper teeth of the upper jaw in the bite state;
wherein the lower surface (233) and/or the upper surface (235) comprises
at least one recess (257) with respect to the lower border and/or the upper border, respectively, and/or
a common annular edge (247, 251, 253, 255) limiting a through hole (249, 252, 254, 256) through the body (241).

2. Auxiliary structure according to claim 1, wherein the through hole (249) is in a region of the body where the lower border (665) coincides with the upper border, thereby defining a portion of a tooth of the upper jaw and/or a tooth of the lower jaw to be diminished for improving the chewing motion, wherein the annular edge of the through hole is in particular visually and/or hapticly marked, in particular using color and/or texture and/or a recognizable surface property that differs when compared to non-marked regions of the body.

3. Auxiliary structure according to claim 1, wherein the recess (257) defines a volume portion to accompany supplement material (458) to be adhered to a tooth (123) that defined a corresponding area of the lower border or the upper border.

4. Auxiliary structure according to claim 1, wherein the recess (257) is in a lateral region where the upper border and the lower border have a relative distance greater than a threshold,
wherein a visual and/or haptic indication at or close to the recess indicating the recess is provided.

5. Auxiliary structure according to claim 1, wherein the recess (257, 457) is adapted to temporally accompany a pre-fabricated solid supplement to be adhered to one of the teeth (123).

6. Auxiliary structure according to claim 1, wherein a filling material duct (461) in communication with the recess (457) is formed in the body (441), the filling material duct leading from the upper surface (435) to the lower surface (433) of the auxiliary structure (440) comprising the recess (457), for allowing excess liquid or viscous filling material (458) to be expelled via the filling material duct (461) to the surface of the auxiliary structure different form the surface of the auxiliary structure at which the recess is arranged.

7. Auxiliary structure according to claim 6, wherein the filling material duct (461) has a lateral extension (d1, d2) that is lower close to the recess than far from the recess, to define a predetermined breaking point (463), when the auxiliary structure is withdrawn after the filling material has solidified or has been adhered to the tooth.

8. Auxiliary structure according to claim 1, wherein
the lower border limits a lower volume occupied by the lower teeth during a chewing motion and
the upper border limits an upper volume occupied by the upper teeth during the chewing motion.

9. Auxiliary structure according to claim 1, wherein the bite state or the chewing motion is a state or motion modified from an original bite state or chewing motion by repositioning a bite/lower jaw rotation axis.

10. Method for manufacturing an auxiliary structure (240, 440, 540) for dental treatment, the method comprising:
providing a 3D model (100, 120) of an upper jaw including plural upper teeth and a lower jaw including plural lower teeth;
using the 3D model to define
a lower border (665) of a lower volume (666) occupied by the lower teeth (123) in a bite state and
an upper border of an upper volume occupied by the upper teeth (103) in the bite state;
defining a geometry of the auxiliary structure (240, 440, 540) based on the lower border and the upper border, thereby
providing, in the auxiliary structure,
at least one recess (257) with respect to the lower border and/or the upper border, and/or
an annular edge (247, 547) common to an upper surface and a lower surface of the auxiliary structure, the common edge limiting a through hole (249, 549) through the auxiliary structure (240, 540).

11. Method according to claim 10, further comprising:
modifying the 3D model by repositioning the lower jaw relative to the upper jaw in particular including repositioning a lower jaw rotation axis;
using the modified 3D model to define
a modified lower border (765) and a modified upper border; and
defining a geometry of the auxiliary structure based on the modified lower border and the modified upper border.

12. Method according to claim 10, further comprising:
manufacturing the auxiliary structure (240, 540) using, in particular thermoplastic and/or thermosetting, material, in particular composite material including plastic,
wherein the material is successively supplied to the growing structure using a 3D-printer to which the defined geometry is supplied,
wherein the material in particular includes fibre material.

13. Method according to claim 10, further comprising:
acquiring, at plural time instances during a chewing motion using the teeth, position data representing positions of the upper teeth relative to positions of the lower teeth;
using/combining the position data to obtain
another lower border (665) of another lower volume occupied by the lower teeth during the chewing motion and
another upper border of another upper volume occupied by the upper teeth during the chewing motion;
defining another geometry of the auxiliary structure based on the other lower border (665) and the other upper border.

14. Method according to claim 13,
wherein the acquiring the position data in particular comprises:
attaching plural position sensors at the lower jaw and a body portion which is fix relative to the upper jaw,
acquiring measurement signals, during the chewing motion, from the plural position sensors,
wherein at least one of the position sensors comprises In particular at least one acceleration sensor.

15. Method of producing a dental supplement for at least one tooth using an auxiliary structure according to claim 1.
